(19) United States
(12) Patent Application Publication
(10) Pub. No.: US 2007/0154768 A1
(43) Pub. Date: Jul. 5, 2007

(54) Fuel cartridge for fuel cell and fuel cell using the same

(76) Inventors: Yoshinori Watanabe, Minato-ku (JP); Yoshimi Kubo, Minato-ku (JP); Tsutomu Yoshitake, Minato-ku (JP); Takashi Manako, Minato-ku (JP); Hiroshi Kajitani, Minato-ku (JP); Hidekazu Kimura, Minato-ku (JP); Satoshi Nagao, Minato-ku (JP); Eiji Akiyama, Minato-ku (JP); Yasutaka Kouno, Minato-ku (JP)

Correspondence Address: SUGHRUE MION, PLLC, 2100 PENNSYLVANIA AVENUE, N.W., SUITE 800, WASHINGTON, DC, 20037, US

(21) Appl. No.: 10/586,860

(22) PCT Filed: Jan. 20, 2005
(86) PCT No.: PCT/JP05/00676

§ 371 Date: Jul. 21, 2006

(30) Foreign Application Priority Data
Jan. 22, 2004 (JP) 2004-014867

(51) Int. Cl. H01M 8/04; B67D 5/64

(52) U.S. Cl. 429/34; 222/160

(57) ABSTRACT

Wall portion 1372 of fuel cartridge 1361 is provided with fuel outlet port 1363 for feeding liquid fuel 124 to fuel cell main body 100 and has an opening for fuel introduction. Detachable fuel injection part 1365 is fitted into the opening for fuel introduction. Fuel injection part 136 of fuel cartridge 1361, after use, is removed from wall portion 1372, and fuel cartridge 1361 is refilled with liquid fuel 124 through the opening for reuse.

### TECHNICAL FIELD

The present invention relates to a fuel cartridge for a fuel cell and a fuel cell using the same.

### BACKGROUND ART

A solid electrolyte type fuel cell includes a fuel electrode and an oxidizer electrode and a solid electrolyte film arranged therebetween. When fuel is supplied to the fuel electrode and an oxidizer is supplied to the oxidizer electrode, electricity is generated by an electrochemical reaction. The fuel electrode and the oxidizer electrode each include a base and a catalytic layer arranged on the surfaces of the base. Hydrogen is generally used as the fuel. However, in recent years, fuel cells using inexpensive and easy-to-handle methanol as a material have been actively developed. For example, there is a methanol reforming fuel cell in which methanol is reformed to generate hydrogen and hydrogen is used as fuel and there is a direct fuel cell that directly uses methanol as fuel.

When methanol is directly used as fuel, the reaction at the fuel electrode is represented by the following equation (1).
CH₃OH+H₂O→6H⁺+CO₂₊6e⁻ (1)

Also, the reaction at the oxidizer electrode is represented by the following equation (2).
3/2O₂+6H⁺+6e⁻→3H₂O (2)

In this way, in the direct fuel cell, because hydrogen ion can be obtained from a methanol solution, a device, like a fuel reformer, is not required and size reduction and weight reduction can be attained. Also, since a methanol solution in liquid is used as fuel, the direct fuel cell has the advantage that energy density is extremely high.

The fuel cell using liquid fuel like this can be used repeatedly when liquid fuel is supplied. Therefore, arrangements of the fuel container stored with liquid fuel have been studied (for example, see Japanese Patent Laid-Open Nos. 2001-93551 and 2003-92128).

Japanese Patent Laid-Open No. 2001-93551 discloses a liquid fuel storage container having a pressure adjustment mechanism. This liquid fuel storage container has a fuel absorption member and supplies fuel to a fuel electrode by using a capillary phenomenon.

Japanese Patent Laid-Open No. 2003-92128 discloses a fuel cartridge having a chamber stored with fuel and a chamber stored with effluent from the fuel cell. Effluent means waste liquid.

The fuel container is preferably reusable in terms of environmental conservation. However, the conventional fuel container is not based on the design philosophy of enabling reuse after one use. Fuel containers disclosed in Japanese Patent Laid-Open Nos. 2001-93551 and 2003-92128 are not configured so that the container can be recovered, can be filled with new fuel, and can be provided to a user in a reusable state again after the fuel stored in the container has been used.

Patent Document 1: Japanese Patent Laid-Open No. 2001-93551

Patent Document 2: Japanese Patent Laid-Open No. 2003-92128

### DISCLOSURE OF INVENTION

The present invention is provided in view of the above situation, and has its object to provide a technique for making a fuel container repeatedly reusable.

The present invention provides a fuel cartridge for a fuel cell, and which is stored with liquid fuel to be directly supplied to a fuel electrode of the fuel cell and that is attachable and detachable to/from said fuel cell, comprising: a fuel supply part for supplying the liquid fuel to the fuel cell; and a fuel introduction part that is a part to insert fuel and that can be opened and closed, for refilling the liquid fuel into the fuel cartridge of the fuel cell. After this fuel cartridge for the fuel cell has been used, while the fuel cartridge for the fuel cell was attached to the fuel cell and the fuel introduction part is closed, the fuel cartridge can be removed from the fuel cell, the fuel introduction part can be opened, thereby discharging the remaining fuel and refilling new fuel. Therefore, the fuel cartridge can be used repeatedly by means of a simple arrangement.

In the fuel cartridge for the fuel cell according to the present invention, an opening is arranged in a wall portion of a storage chamber stored with the liquid fuel, the fuel introduction part includes the opening and a closing member for closing the opening, and the closing member is attachable and detachable to/from the wall portion. According to this arrangement, the fuel introduction part is securely closed when the fuel cartridge is used. Also, the closing member can be removed from the wall portion after used. Therefore, the fuel introduction part is opened, thereby discharging the remaining fuel and refilling with new fuel. Then, the closing member can be attached again after fuel is refilled. Therefore, the fuel cartridge can be repeatedly used even more easily.

In the fuel cartridge for the fuel cell according to the present invention, the closing member may be a stopper to be fitted into the opening. Based on this arrangement, the opening can be opened and securely closed by means of a simple arrangement.

In the fuel cartridge for the fuel cell according to the present invention, the fuel supply part is arranged in the fuel introduction part. The fuel supply part is arranged in the fuel introduction part, thereby simplifying the whole arrangement of the fuel cartridge for the fuel cell.

In the fuel cartridge for the fuel cell according to the present invention, the fuel supply part is sealed by a self-sealing member. Here, the self-sealing member is a member having a characteristic of sealing between a pointed member such as a needle and a pieced member at the pierced portion thereof, when being pierced by the pointed member. A cover member is made of an elastic material, such as rubber, whereby the cover member is elastically deformed when being pieced by a pointed member like a needle, and the pointed member and the pierced member are suitably sealed. As self-sealing members, for example, septum made of silicon rubber or the like and re-seal made of ethylene propylene or the like can be used. Additionally, vulcanized rubber may be used for a portion that is pierced by a pointed member. In this case, a slit may be arranged in the rubber, and a lubricant, such as silicon oil, may be applied to the side wall of the slit. In this way, the fuel supply part is sealed by the self-sealing member, thereby preventing the liquid fuel stored in the fuel cartridge for the fuel cell from leaking to the outside of the cartridge. Therefore, the fuel cartridge for the fuel cell can be further safely used.

The fuel cartridge for the fuel cell according to the present invention may have a first chamber for holding the liquid fuel; a second chamber to which effluent that has passed through the fuel electrode is introduced; and a partition wall for partitioning the first chamber and the second chamber: wherein the first chamber has the fuel supply part and the fuel introduction part, and wherein the second chamber has an effluent recovery port to which the effluent recovered from the fuel electrode is introduced.

Here, the effluent includes the redundant liquid fuel that is discharged through the fuel electrode and the water generated at the oxidizer electrode by the cell reaction. The fuel cartridge for the fuel cell according to the present invention has the effluent recovery port, thereby recovering the effluent including unused liquid fuel that has passed through the fuel electrode efficiently. Also, the partition wall is arranged between the second chamber in which effluent is recovered and the first chamber in which the liquid fuel is stored, thereby preventing them from being mixed and supplying the liquid fuel to the fuel electrode stored in the first chamber at a suitable concentration.

In the fuel cartridge for the fuel cell according to the present invention, the second chamber has an effluent discharge part that can be opened and closed and that is used to discharge the effluent. Based on this arrangement, after the fuel cartridge for the fuel cell has been used, the fuel cartridge can be removed from the fuel cell and the recovered effluent can be discharged through the effluent discharge part. Therefore, repeated use becomes easy.

In the fuel cartridge for the fuel cell according to the present invention, the effluent discharge part may be provided with the effluent recovery port. The effluent recovery port is arranged in the effluent discharge part, thereby simplifying the whole arrangement of the fuel cartridge for the fuel cell.

In the fuel cartridge for the fuel cell according to the present invention, the effluent recovery port is sealed by a self-sealing member. Based on this arrangement, effluent can be prevented from leaking to the outside of the cartridge. Therefore, safety of the fuel cartridge for the fuel cell can be improved.

In the fuel cartridge for the fuel cell according to the present invention, a part of the fuel introduction part is made of a fuel absorption member that absorbs the liquid fuel, and the fuel absorption member is arranged in said fuel cartridge. Based on this arrangement, while the liquid fuel stored in the fuel cartridge for the fuel cell is absorbed by the fuel absorption member, the fuel cartridge can be attached to the fuel cell and can be used. Therefore, when the amount of the fuel remaining in the cartridge is small, the liquid fuel can be supplied from the fuel supply part to the fuel cell through the fuel absorption member. Therefore, the fuel cell can be stably operated.

In the fuel cartridge for the fuel cell according to the present invention, the fuel absorption member may be detachable from the fuel introduction portion. Based on this arrangement, for example, when the fuel introduction part is removed from the fuel cartridge for the fuel cell and the fuel cartridge is refilled with fuel, the fuel absorption member can be replaced easily. Therefore, the cartridge can be used for a longer period.

The fuel cartridge for the fuel cell according to the present invention can be stored in an electric device. Based on this arrangement, the electric device can be used while the fuel cartridge for the fuel cell is stored in the electric device. Therefore, the electric device can be stability operated. Also, in this case, since the fuel cartridge for the fuel cell has the fuel introduction part, liquid fuel can be prevented from leaking when the device is used. Also, the fuel cartridge can be reused easily after having been used. Further, the fuel cartridge for the fuel cell according to the present invention may be stored in the electric device while a part of the surface thereof is exposed. Also, the fuel cartridge may be stored in the electric device while a part of the surface projects from the electric device. Also, the fuel cartridge for the fuel cell according to the present invention may be stored in the electronic device without having any part projected or exposed. Based on this arrangement, the electric device can be operated still more stably.

The present invention provides a fuel cell including: a fuel cell main body having a fuel electrode; and the fuel cartridge for the fuel cell according to any one of the above-mentioned arrangements, stored with liquid fuel to be directly supplied to the fuel electrode. Since the fuel cell according to the present invention has the fuel cartridge with the fuel introduction part that can be opened and closed, the fuel in the cartridge can be refilled easily.

The fuel cell according to the present invention can be applied to, for example, a compact electronic device, such as a mobile phone, a notebook personal computer, a PDA (Personal Digital Assistant), various cameras, a navigation system, a portable music player.

Incidentally, any combination of each element, various devices, to which the fuel cartridge for the fuel cell or the fuel cell according to the present invention is applied, and methods of manufacturing and using these, are also available as aspects of the present invention.

### BRIEF DESCRIPTION OF THE DRAWINGS

FIG. 1 is a view showing an arrangement of a fuel cell according to the first embodiment of the present invention.

FIG. 2 is a cross-sectional view taken along line A-A′ in FIG. 1.

FIG. 3 is an enlarged view showing a fuel introduction part of the fuel cartridge shown in FIG. 2.

FIG. 4 is a drawing, viewed in a direction indicated by arrows B, B′ in FIG. 3.

FIG. 5 is a cross-sectional view taken along line C-C′ in FIG. 1.

FIG. 6 is an enlarged view showing a connecting portion between the fuel cartridge and the fuel cell shown in FIG. 1.

FIG. 7 is a schematic view showing one example of an electrical device in which the fuel cell according to the present invention is mounted.

FIG. 8a is a schematic view showing another example of an electrical device in which the fuel cell according to the present invention is mounted.

FIG. 8b is a schematic view showing further another example of an electrical device in which the fuel cell according to the present invention is mounted.

FIG. 9 is a cross-sectional view showing an arrangement of a fuel cartridge according to the second embodiment of the present invention.

FIG. 10 is an enlarged view showing a fuel introduction part of the fuel cartridge shown in FIG. 9.

FIG. 11 is an enlarged view showing another example of the fuel introduction part of the fuel cartridge shown in FIG. 9.

FIG. 12 is an enlarged view showing yet another example of the fuel introduction part of the fuel cartridge shown in FIG. 9.

FIG. 13 is a view showing an arrangement of a fuel cell main body corresponding to the fuel cartridge shown in FIG. 12.

FIG. 14 is a cross-sectional view taken along line A-A′ in FIG. 12.

FIG. 15 is a cross-sectional view showing an arrangement of a fuel cartridge according to the third embodiment of the present invention.

FIG. 16 is an enlarged view showing an effluent discharge part of the fuel cartridge shown in FIG. 15.

FIG. 17 is a view showing an arrangement of a fuel cell according to the third embodiment of the present invention.

FIG. 18 is a view showing another arrangement of the fuel cell according to the third embodiment of the present invention.

FIG. 19 is a cross-sectional view showing an arrangement of a fuel cartridge according to the fourth embodiment of the present invention.

FIG. 20 is an enlarged view showing a fuel introduction part of the fuel cartridge shown in FIG. 19.

### BEST MODE FOR CARRYING OUT THE INVENTION

Hereinafter, embodiments of the present invention will be explained with reference to drawings. Incidentally, the same reference numerals are applied to common elements and explanations thereof are omitted, as appropriate.

### FIRST EMBODIMENT

The first embodiment of the present invention relates to a reusable fuel cartridge that can be removed from a fuel cell and can be refilled with liquid fuel after use. In this description, explanations are mainly given of an aspect of a fuel introduction part including a fuel refill port provided on a wall portion of a fuel cartridge and a stopper for sealing the fuel refill port according to the first embodiment.

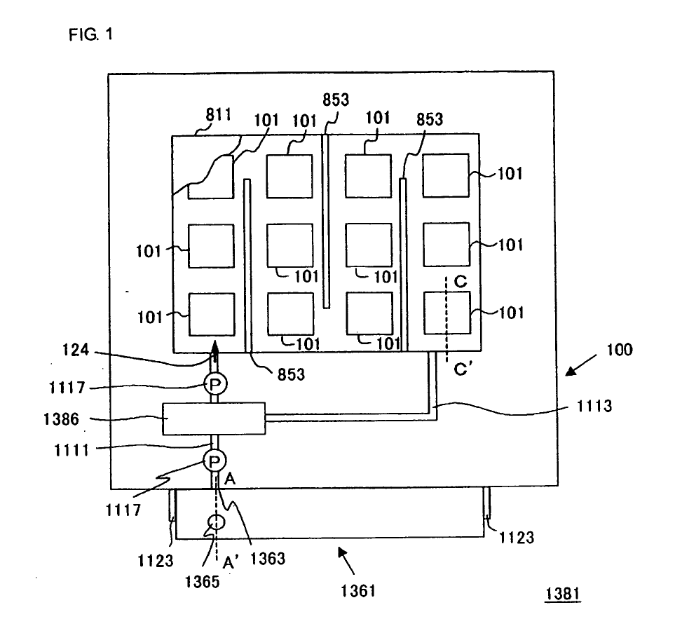

FIG. 1 is a view showing a fuel cell according to the first embodiment. Fuel cell 1381 shown in FIG. 1 has fuel cell main body 100 and fuel cartridge 1361. Fuel cartridge 1361 is attachable and detachable to/from fuel cell main body 100 and is a container for holding liquid fuel to be directly supplied to fuel cell main body 100.

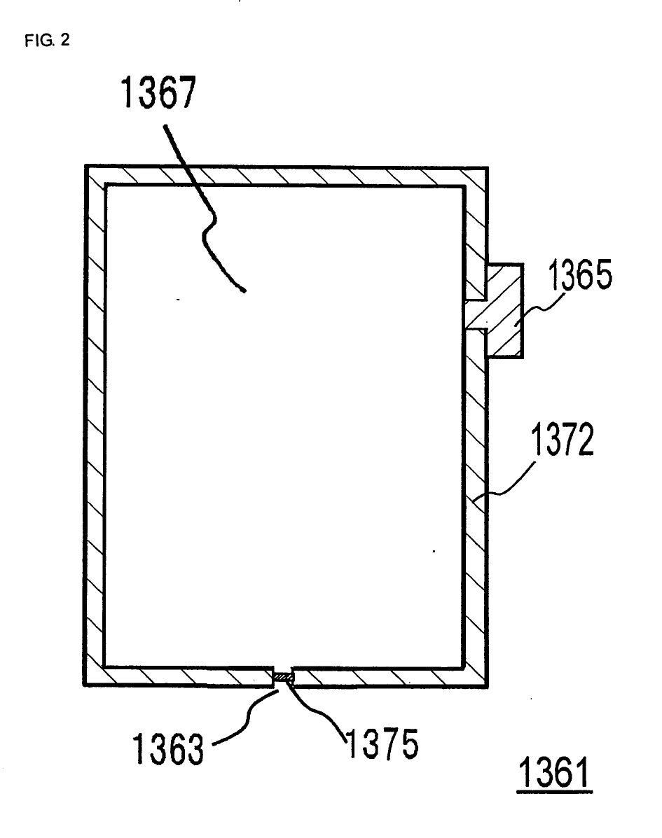

FIG. 2 is a cross-sectional view taken along line A-A′ in FIG. 1. In fuel cartridge 1361, liquid fuel is stored in electric generation fuel chamber 1367. Wall portion 1372 of fuel cartridge 1361 is provided with fuel outlet port 1363 for feeding liquid fuel to fuel cell main body 100. Fuel outlet port 1363 is a hole through wall portion 1372, and is sealed by seal member 1374 that is arranged inside.

Seal member 1375 is a self-sealing elastic member. As seal member 1375, for example, septum and reseal can be used. Preferably, seal member 1375 is resistant to liquid fuel and is made of material that can provide a hermetic seal. As materials like this, elastomer such as ethylene-propylene rubber and silicone rubber can be used. When seal member 1375 is made of ethylene-propylene rubber, copolymer of ethylene and propylene (EPM) or copolymer of ethylene, propylene, and the third component (EPDM) may be used. Also, seal member 1375 may be made of vulcanized rubber.

Fuel injection part 1365 is attached to an opening provided in wall portion 1372 of fuel cartridge 1361. Fuel injection part 1365 is threadably mounted on wall portion 1372 and is relatively tightly fixed, however, fuel injection part 1365 can be removed from wall portion 1372 when the fuel cartridge is recycled, as described later. When fuel injection part 1365 is removed, the opening in wall portion 1372 is exposed in that portion, and therefore liquid fuel can be refilled from the opening.

Here, considerations may be given to fuel injection part 1365 so that a user of fuel cell 1381 does not open fuel injection part 1365 accidentally, for example, a screw with a screw head in a special shape may be available. For example, the screw may be configured as follows.

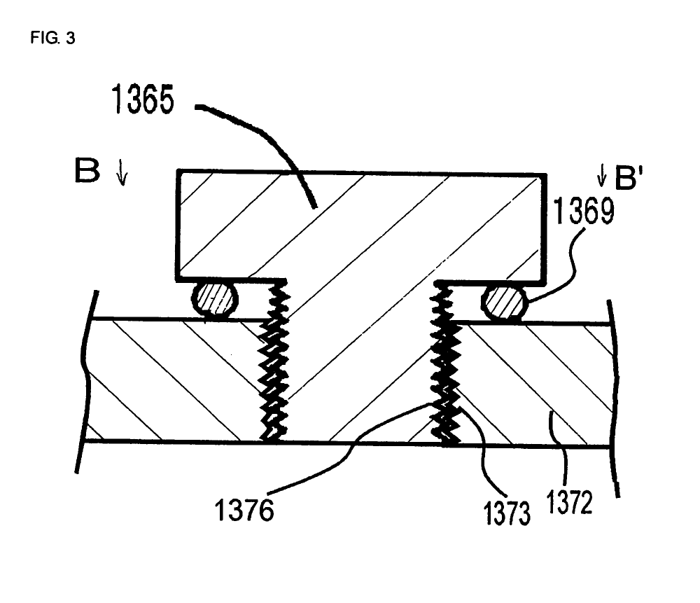

FIG. 3 is an enlarged view of wall portion 1372 near fuel injection part 1365. As shown in FIG. 3, wall portion 1372 has an opening, and thread portion 1373 is formed in the inner wall surface of the opening. Fuel injection part 1365 is fixed by screwing thread portion 1376 to thread portion 1373 of wall portion 1372, and closes the opening. In this description, thread portion 1376 of fuel injection part 1365 is an external screw and thread portion 1373 of wall portion 1372 is an internal thread.

Since fuel injection part 1365 is screwed to wall portion 1372 of fuel cartridge 1361, fuel injection part 1365 can be removed after use, and liquid fuel can be refilled into fuel cartridge 1365. Then, after liquid fuel is refilled, fuel injection part 1365 is reattached to wall portion 1372, thereby sealing the opening. Also, fuel injection part 1365 can be used as a discharge port for the remaining fuel that is left as unused in fuel cartridge 1361, when liquid fuel is refilled.

O-ring 1369 is arranged in the external surface of fuel cartridge 1361 between wall portion 1372 and fuel injection part 1365. O-ring 1369 is arranged near the base of thread portion 1373, thereby preventing the liquid fuel from leaking near fuel injection part 1365 to the outside of fuel cartridge 1361.

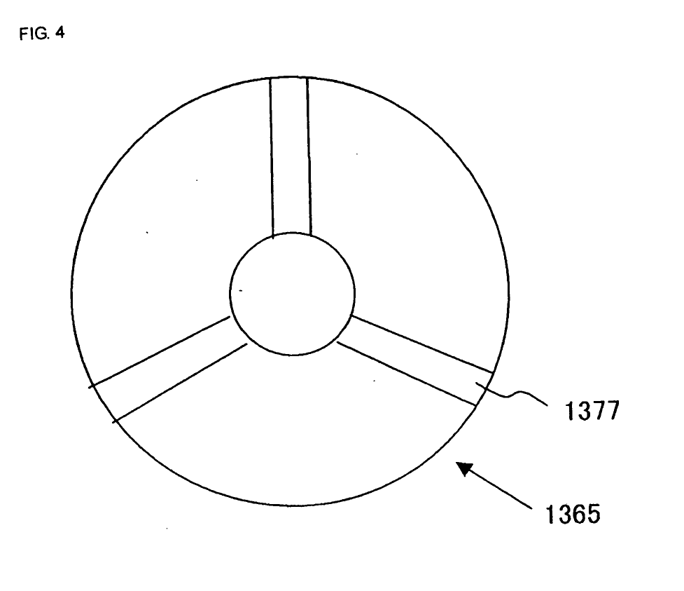

FIG. 4 is a drawing viewed in a direction indicated by arrows B, B′ in FIG. 3. As shown in FIG. 4, Y-shaped groove 1377 is arranged on the surface of fuel injection part 1365. Therefore, fuel injection part 1365 can be attached to wall portion 1372, by using a Y-shaped screwdriver corresponding to the form of Y-shaped groove 1377.

Wall portion 1372, fuel injection part 1365, seal member 1375, and O-ring 136, which constitute fuel cartridge 1361, are preferably formed by a material that is resistant to fuel components in the liquid fuel. For example, fuel cartridge 1361 can be formed by resin, such as polyolefin, like polypropylene and polyethylene, polycarbonate, polyvinyl chloride, polyether ether ketone, polysulphone, silicon, or copolymer thereof, and mixtures thereof.

Incidentally, fuel injection part 1365 and/or the vicinity of the opening in wall portion 1372 to which fuel injection part 1365 is screwed may be formed of a material with high mechanical strength. According to this arrangement, the strength of fuel injection part 1365 and/or the vicinity of fuel injection part 1365 is improved. Therefore, abrasion or the like in thread portion 1376 and thread portion 1373 can be prevented and fuel cartridge 1361 can be made as a cartridge that is more suitable for repeated use. Also, the surface of screw portion may be covered by a tape made of fluorine resin, such as Daiflon (registered trademark). According to this arrangement, the stored liquid fuel can be prevented from leaking to the outside of the cartridge with more reliability.

Referring to FIG. 1 again, explanations are given of an arrangement of fuel cell main body 100. Fuel cell main body 100 includes a plurality of single cell structures 101, fuel container 811, partition plate 853, fuel flow pipe 1111, fuel recovery pipe 1113, reservoir tank 1386, pump 1117, and connector 1123. Fuel cartridge 1361 is configured so as to be attachable and detachable to/from fuel cell main body 100 by connector 1123. Also, not shown in FIG. 1, fuel cell main body 100 has an oxidizer electrode side effluent recovery pipe that is used to recover water generated by the cell reaction at the oxidizer electrode of single cell structure 101.

In this arrangement, liquid fuel 124 stored in fuel cartridge 1361 is supplied to single cell structure 101. Namely, pump 1117 is arranged in fuel flow pipe 1111. Fuel flow pipe 1111 is connected to fuel container 811 through reservoir tank 1386. Therefore, fuel 124 is supplied to fuel container 811 through fuel flow pipe 1111. Fuel 124 that is flowed into fuel container 811 flows along the plurality of partition plates 853 arranged in fuel container 811 and is sequentially supplied to the plurality of single cell structures 101. Of fuel 124 that is supplied to single cell structure 101, fuel 124 that is not used in the cell reaction is recovered in reservoir tank 1386 from fuel recovery pipe 1113. Remaining fuel that is recovered is mixed with water which is recovered from the oxidizer electrode side effluent recovery pipe (not shown) and fuel 124 which is supplied from fuel cartridge 1361, and then is supplied from fuel flow pipe 1111 to fuel container 811 once again.

As pump 1117, for example, a piezoelectric element, such as a compact piezoelectric motor with low power consumption, can be used. Also, not shown in FIG. 1, fuel cell 1381 according to the first embodiment may be provided with a control section for controlling the operation of pump 1117.

Incidentally, in the first embodiment and the following embodiments, liquid recovered from fuel recovery pipe 1113 and the oxidizer electrode side effluent recovery pipe is called effluent. The effluent includes the liquid fuel that was not used for the cell reaction in the cell electrode and the water generated in the oxidizer electrode.

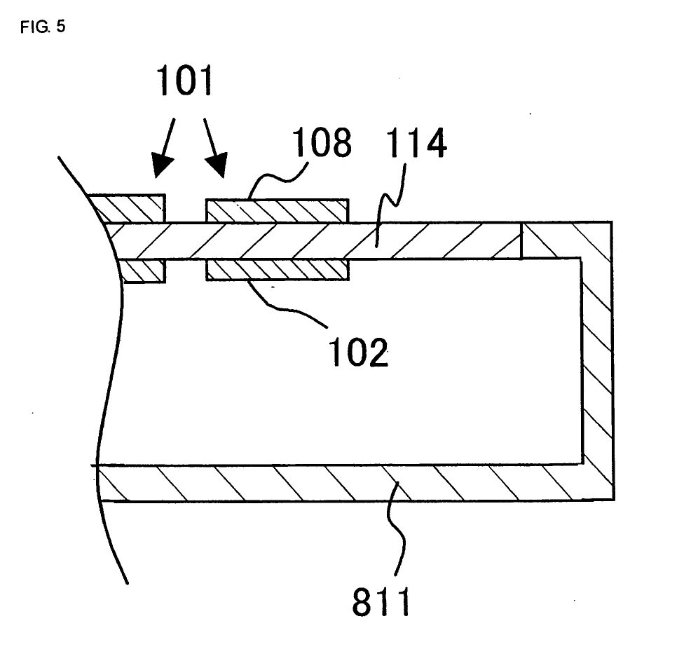

FIG. 5 is a cross-sectional view taken along line C-C′. Single cell structure 110 includes fuel electrode 102, oxidizer electrode 108, and solid electrolyte film 114. A plurality of fuel electrodes 102 is arranged on one surface of one solid electrolyte film 114, and a plurality of oxidizer electrodes 108 is arranged on another surface. Also, fuel container 811 is in contact with fuel electrode 102.

Solid electrolyte film 114 separates fuel electrode 102 and oxidizer electrode 108 and acts to move hydrogen ions therebetween. Therefore, preferably, solid electrolyte film 114 is a film having a high conductivity for hydrogen ions. Also, preferably, solid electrolyte film 114 is chemically suitable and mechanically strong. As a material to form solid electrolyte film 114, organic polymer having a polar group, such as a strong acid group, like sulfone group and phosphate group, or a weak acid group, like carboxyl group, is preferably used. As an organic polymer like this, sulfonated poly (4-phenoxy benzoyl-1,4-phenylene), aromatic series condensed polymer, such as alkyl sulfonic poly benzimidazole; sulfone-base-containing perfluorocompounds (Nafion (manufactured by Dupont CO., LTD: registered mark) and Aciplex (manufactured by Asahi KASEI CO., LTD: registered mark), or carboxyl-base-containing perfluorocompounds (Flemion S fim (manufactured by Asahi GLASS CO., LTD) are mentioned as examples.

Each of fuel electrode 102 and oxidizer electrode 108 may be provided by forming a fuel electrode side catalyst layer and an oxidizer electrode side catalyst layer including carbon particles supporting catalyst and solid electrolyte particles on each substrate.

As catalysts for the fuel electrode side catalyst layer, platinum, gold, silver, ruthenium, rhodium, palladium, osmium, iridium, cobalt, nickel, rhenium, lithium, lanthanum, strontium, yttrium, and alloys thereof are mentioned as examples. As catalysts for the oxidizer electrode side catalyst layer used in oxidizer electrode 108, the same catalysts as in the fuel electrode side catalyst layer can be used, and the above-mentioned substances can be used. Incidentally, the same catalyst or different catalysts may be used for the fuel electrode side catalyst layer and the oxidizer electrode side catalyst layer.

As bases of both fuel electrode 102 and oxidizer electrode 108, a porous substrate, such as a carbon paper, a carbon compound, a carbon sintered compound, sintered metal, and foam metal, may be used.

In fuel cell main body 100 arranged in this way, fuel 124 is supplied to fuel electrode 102 in each cell structure 101. Also, oxidizer is supplied to oxidizer electrode 108 in each cell structure 101. As fuel 124, liquid fuel, such as methanol, ethanol, dimethyl ether, or other alcohols, and liquid hydrocarbon like cycloparaffin, formalin, formic acid, or hydrazine, can be used, and aqueous solutions thereof can also be used. Also, alkali can be added to fuel 124 to enhance the ion conductivity of hydrogen ions. As the oxidizer, usually, air can be used, however, oxygen gas may be supplied.

Referring to FIG. 1 once again, next, explanations are given of how to use fuel cartridge 1361. Fuel cartridge 1361 prior to use is filled with liquid fuel 124, fuel outlet port 1363 is sealed, and fuel injection part 1365 is closed.

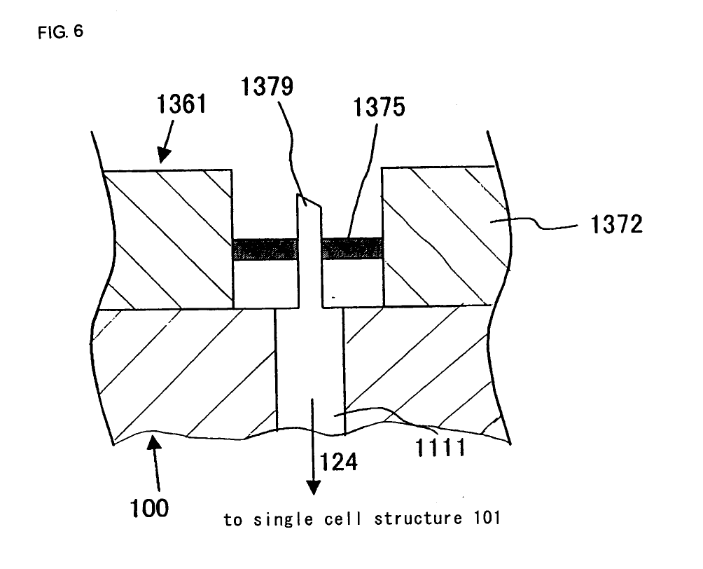

When fuel cartridge 1361 is used, fuel cartridge 1361 is attached to connector 1123 of fuel cell main body 100. FIG. 6 is an enlarged view showing a connecting portion between fuel cartridge 1361 and fuel flow pipe 1111. As shown in FIG. 6, hollow needle 1379 is arranged at the tip of fuel flow pipe 1111 of fuel cell main body 100. When fuel cartridge 1361 is attached to fuel cell main body 100, hollow needle 1379 penetrates seal member 1375. Therefore, the liquid fuel in fuel cartridge 1361 is fed to fuel flow pipe 1111. Since this fuel flow pipe 1111 is connected to fuel electrode 102 in single cell structure 101, as described above, fuel 124 is supplied to fuel electrode 102.

Incidentally, seal member 1375 has a self-sealing characteristic. Therefore, seal member 1375 is in intimate contact with the periphery of hollow needle 1379 when hollow needle 1379 is penetrated, and hermeticity is ensured. Therefore, liquid fuel can be suitably prevented from leaking. Also, when hollow needle 1379 is removed, the hole is closed and air tightness is ensured.

After fuel cartridge 1361 is used, fuel cartridge 1361 can be removed from fuel cell main body 100. Fuel cartridge 1361 that is removed is reusable. When fuel cartridge 1361 is reused, fuel injection part 1365 is removed from wall portion 1372 by using the Y-shaped screwdriver. Fuel injection part 1365 is removed and then opening of wall portion 1372 is exposed, and therefore the liquid remaining in power generation fuel chamber 1367 is discharged from the opening. After that, liquid fuel is refilled in power generation fuel chamber 1367, and then fuel injection part 1365 is attached to wall portion 1372 once again.

Fuel cartridge 1361 according to the first embodiment can be refilled with liquid fuel, after liquid fuel 124 stored in fuel cartridge 1361 has been used. Also, before liquid fuel 124 is refilled, remaining fuel in fuel cartridge 1361 can be removed. For example, in a case where, first, fuel 124 is stored in fuel cartridge and fuel injection part 1365 is closed and then fuel injection part 1365 cannot be detached from wall portion 1372, fuel cartridge 1361 cannot be refilled with fuel 124 and cannot discharge fuel 124, for example, unless seal member 1375 is pierced with a hollow needle for fuel injection. These operations are relatively difficult. On the other hand, according to the arrangement of the first embodiment, fuel cartridge 1361 that is suitable for repeated use and that has a simple arrangement is stably made.

Also, fuel injection part 1365 that is removed when liquid fuel 124 is refilled, is threadably mounted on wall portion 1372 relatively tightly. Fuel injection part 1365 is relatively tightly fixed to wall portion 1372 and is usually closed, and is attached and detached by using the Y-shaped screwdriver. In this way, since fuel cell 1381 is configured so that the user cannot remove fuel injection part 1365 by mistake, and safety is ensured when fuel cell 1381 is used.

Further, fuel cartridge 1361 may be provided with a pressure adjustment mechanism for adjusting the pressure in power generation fuel chamber 1367. Based on this arrangement, liquid fuel 124 in power generation fuel chamber 1367 can be supplied to fuel cell main body more efficiently. Also, safety can be improved when fuel cartridge 1361 is used.

Also, a gas-liquid separation film may be arranged in fuel recovery pipe 1113 shown in FIG. 1. According to this arrangement, gas, such as carbon dioxide, generated at fuel electrode 102 can be selectively discharged to the outside of fuel recovery pipe 1113, and liquid can be recovered in reservoir tank 1386. In the arrangement in FIG. 1, fuel recovery pipe 1113 is connected to reservoir tank 1386. However, the redundant fuel that passes through single cell structure 101 may be recovered to fuel cartridge 1361 from fuel recovery pipe 1113.

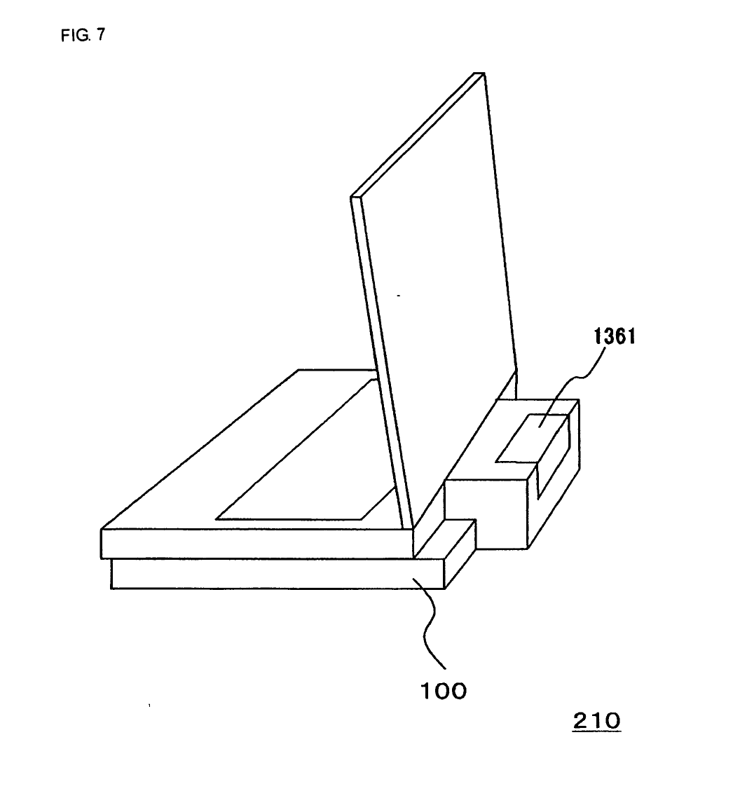

FIG. 7 is a schematic view showing one example of an electronic device on which the aforementioned fuel cell is mounted, and shows a portable personal computer.

Portable personal computer 210 has a construction in which fuel cell main body 100 is provided at the bottom portion thereof and fuel cartridge 1361 is attached to the back portion thereof. Fuel cartridge 1361 is stored in portable personal computer 210 and a part of the surface of fuel cartridge 1361 is exposed. Due to this arrangement, fuel cartridge 1361 can be attached while keeping portable personal computer 210 compact. Also, since fuel cartridge 1361 has detachable fuel injection part 1365 (not shown in FIG. 7), fuel cartridge 1361 can be removed from portable personal computer 210 easily after use, and can be reused in the above-mentioned method.

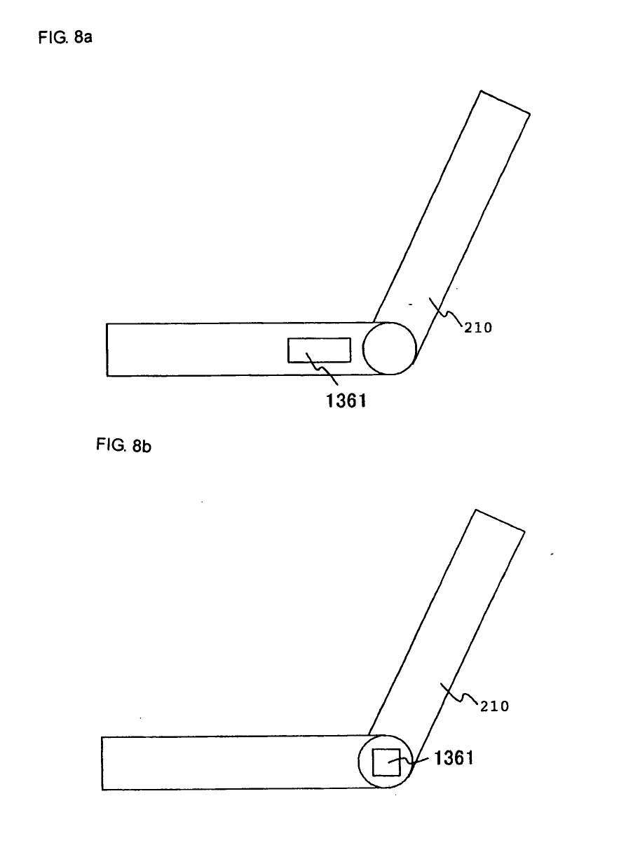

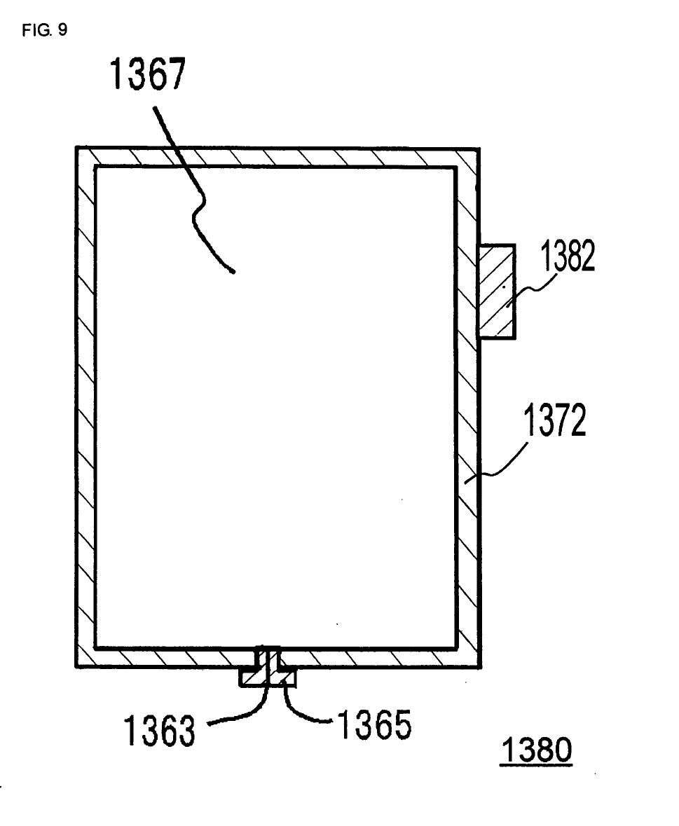

Further, the mounting method of fuel cell main body 100 and fuel cartridge 1361 is not limited to the aspect shown in FIG. 7, and another aspect is also available. For example, fuel cartridge 1361 may be stored in portable personal computer 210. FIGS. 8a and 8b are cross-sectional views of portable personal computer 210 in which fuel cartridge 1361 is stored. In the arrangement shown in FIG. 8a, fuel cartridge 1361 is completely stored in the bottom portion of potable personal computer 210. In the arrangement shown in FIG. 8b, fuel cartridge 1361 is stored in the hinge portion of potable personal computer 210.

Based on these arrangements, greater reliability can be ensured during the operation of fuel cell min body 100 and fuel cartridge 1361. At this time, fuel cartridge 1361 can be reduced in size, thereby reducing portable personal computer 210 in size and in weight.

Conventionally, because a fuel container that is to be stored in portable personal computer 210 is not deigned in terms of reuse, the fuel container is thrown away after one use. On the other hand, according to the first embodiment, because compact fuel cartridge 136 that is to be stored in portable personal computer 210 has detachable fuel injection part 1365, fuel cartridge 136 can be reused after use.

### SECOND EMBODIMENT

FIG. 9 is a cross-sectional view showing a fuel cartridge according to the second embodiment of the present invention, viewed from the same direction as FIG. 2. In the fuel cartridge according to the second embedment, fuel injection part 1365 has fuel outlet port 1363. Specifically, in fuel cartridge 1380 in FIG. 9, fuel injection part 1365 is arranged in wall portion 1372, and fuel outlet port 1363 through fuel injection part 1365 is formed.

Also, fuel cartridge 1380 has pressure adjustment part 1382. As pressure adjustment part 1382, specifically, a selective permeable membrane that does not allow liquid fuel to pass, can be used, as an example. As a selective permeable membrane, a material that hardly allows vaporized fuel of liquid fuel to pass may be used, specifically, polytetrafluoroethylene (PTFE) can be mentioned. Such pressure adjustment part 1382 is arranged, thereby preventing power generation fuel chamber 1367 from being in negative pressure and thereby reliably supplying liquid fuel in power generation fuel chamber 1367 to fuel cell main body 100.

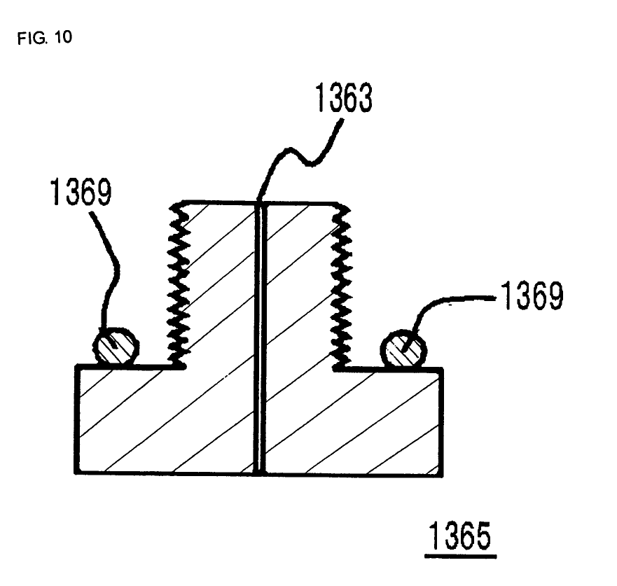

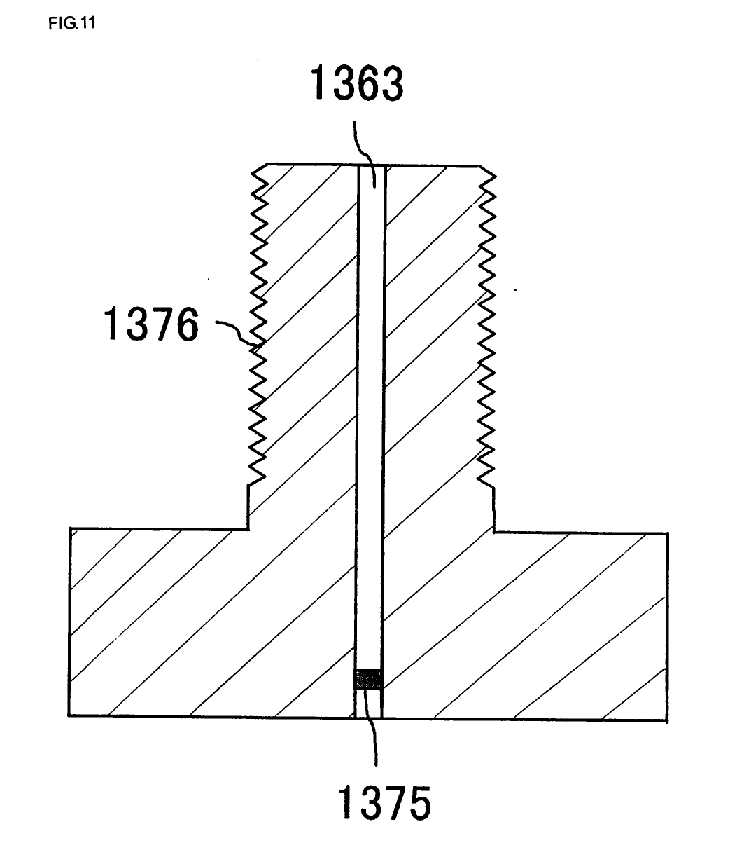

FIG. 10 is a view showing an arrangement of fuel injection part 1365. The principle arrangement of fuel injection part 1365 is similar to fuel injection part 1365 of fuel cartridge 1361 according to the first embodiment in FIG. 3, however, they are different in that fuel outlet port 1363 for communicating the inside and the outside of fuel cartridge 1380 is present in fuel injection part 1365 shown in FIG. 10, but it is not present in fuel injection part 1365 shown in FIG. 3. The liquid fuel stored in fuel cartridge 1380 is supplied to fuel cell main body 100 through fuel outlet port 1363. Incidentally, as shown in FIG. 11, in fuel injection part 1365 in FIG. 10, fuel outlet port 1363 may also be sealed by seal member 1375, similar to the arrangement shown in FIG. 2.

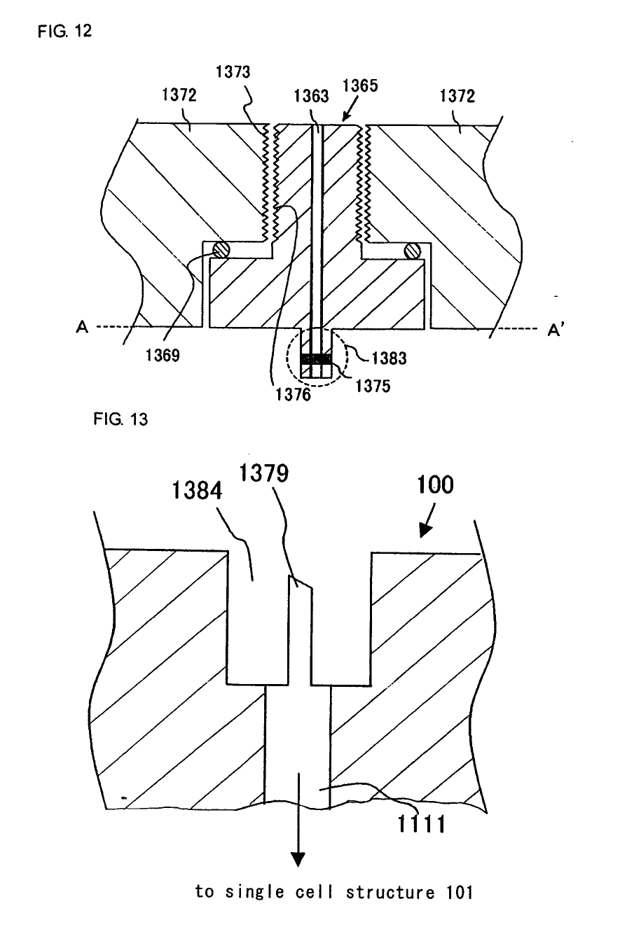

FIG. 12 is a view showing another arrangement of fuel injection part 1365. The principle arrangement of fuel injection part 1365 shown in FIG. 12 is similar to fuel injection part 1365 shown in FIG. 10, however, they are different in that projection portion 1383 that projects to the outside of fuel cartridge 1380 is provided and seal member 1375 is arranged in projection portion 1383.

FIG. 13 is a view showing an arrangement of fuel cell main body 100 that is suitable for use with fuel injection part 1365 shown in FIG. 12, viewed from the same direction as FIG. 6. As shown in FIG. 13, fuel cell main body 100 has concave portion 1384 in the wall portion, and hollow needle 1379 is formed in concave portion 1384. The height of the tip of hollow needle 1379 is lower than the height of the opening end of concave portion 1384. When projection portion 1383 is fitted into concave portion 1384, hollow needle 1379 penetrates seal member 1375, and the liquid fuel in fuel cartridge 1380 is supplied to fuel flow pipe 1111.

When the arrangements shown in FIGS. 12 and 13 are used, the height of the tip of hollow needle 1379 can be made lower than the height of the opening end of concave portion 1384 in fuel cell main body 100. Therefore, safety can be improved when the user of the fuel cell attaches fuel cartridge 1380 to fuel cell main body 100.

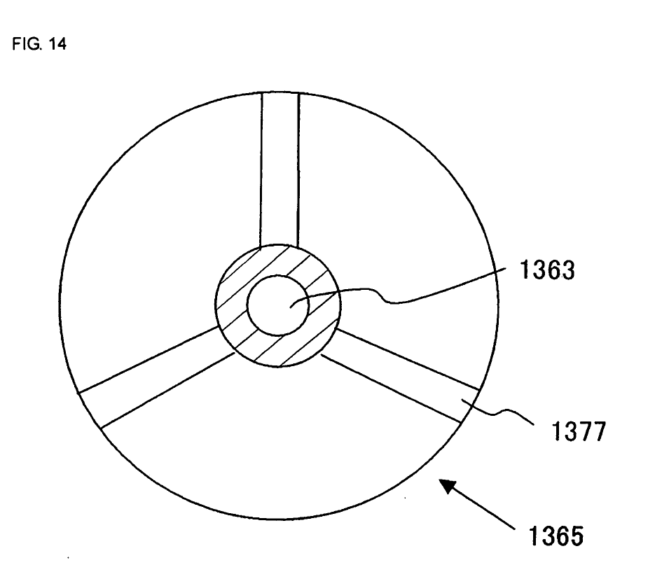

FIG. 14 is a cross-sectional view taken along line A-A′ of fuel injection part 1365 shown in FIG. 12. Fuel injection part 1365 shown in FIG. 12 is also provided with Y-shaped groove 1377 on the surface. Therefore, after use, fuel injection part 1365 can be removed from wall portion 1372 by using a tool provided with a convex portion corresponding to the shape of Y-shaped groove 1377 and provided with a concave portion corresponding to the shape of projection portion 1383, and then liquid fuel can be refilled. Fuel injection part 1365 is configured to be detachable by using a tool, like this, thereby preventing fuel injection part 1365 from being removed by mistake, when the cartridge is being used. Therefore, safety of fuel cartridge 1380 can be further improved.

In fuel cartridge 1380 according to the second embodiment, fuel outlet port 1363 is formed in fuel injection part 1365. Then, after fuel cartridge 1380 is used repeatedly, and when seal member 1375 needs to be changed, only fuel injection part 1365 may be changed. Therefore, the main body of fuel cartridge 1380 can be simplified and fuel cartridge 1380, suitable for repeated use, can be stably obtained.

### THIRD EMBODIMENT

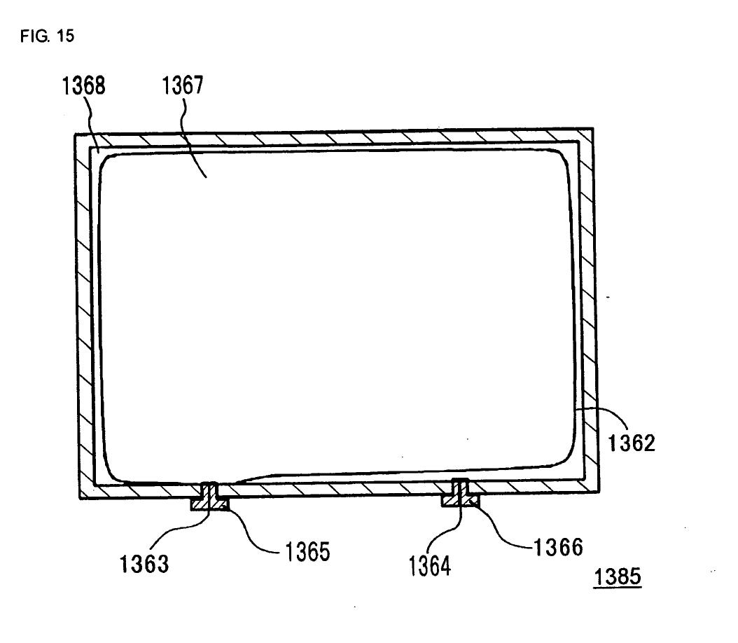

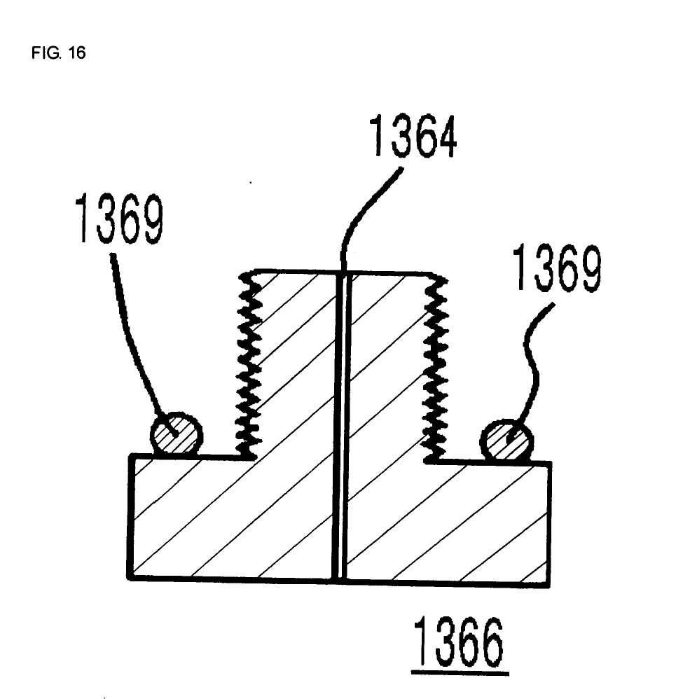

FIG. 15 is a cross-sectional view showing an arrangement of a fuel cartridge according to the third embodiment of the present invention. Fuel cartridge 1385 shown in FIG. 15 is divided into two chambers by partition wall 1362. One chamber is power generation fuel chamber 1367 and another chamber is power generation effluent chamber 1368.

The material of partition wall 1362 may be similar to those, mentioned as constituent materials for fuel cartridge 1361 of the first embodiment, as examples. Also, partition wall 1362 may be a flexible material. According to this arrangement, liquid fuel in power generation fuel chamber 1367 is reduced as fuel cartridge 1385 is used, and the shape of partition wall 1362 is changed in response to the increase in the effluent in power generation effluent chamber 1368. Therefore, liquid fuel can be supplied to fuel cell main body 100 efficiently, and effluent can be reliably recovered in power generation effluent chamber 1368. As flexible materials, specifically, for example, polymer materials, such as polyethylene, polypropylene, and polyvinylidene chloride, may be used.

Liquid fuel 124 is stored in power generation fuel chamber 1367. Fuel injection part 1365 is attached to the wall portion that partitions power generation fuel chamber 1367 from the outside, and fuel outlet port 1363 is arranged in this fuel injection part 1365. Therefore, liquid fuel 124 is supplied to fuel cell main body 100 through fuel outlet port 1363.

Also, fuel outlet part 1366 is attached to the wall portion that partitions power generation effluent chamber 1368 from the outside, and effluent recovery port 1364 is arranged in this fuel outlet part 1366. Power generation effluent generated in fuel cell main body 100 is recovered in power generation effluent chamber 1368 through effluent recovery port 1364. Because fuel cartridge 1385 has power generation effluent chamber 1368 in addition to power generation fuel chamber 1367, a part of effluent generated by the cell reaction in fuel cell main body 100 can be efficiently recovered in the cartridge.

Fuel outlet part 1366 is screwed to the wall portion that partitions power generation effluent chamber 1368 from the outside in fuel cartridge 1385. After fuel cartridge 1385 is used, fuel cartridge 1385 is removed from fuel cell main body 100, and fuel outlet port 1366 can be opened and the power generation effluent recovered in fuel cartridge 1385 can be discharged, as required. Also, after the power generation effluent is discharged, fuel outlet port 1366 can be closed again and fuel cartridge 1385 can be reused.

FIG. 16 is a cross-sectional view showing an arrangement of effluent discharge part 1366. Effluent discharge part 1366 shown in FIG. 16 has a thread to be fixed to fuel cartridge 1385 by screwing, similar to fuel injection part 1365. Also, effluent recovery port 1364 is arranged at the center of effluent discharge part 1366 to penetrate it. As well, effluent recovery port 1364 is fitted in fuel cartridge 1385 while O-ring 1369 is arranged at the base of the thread head. Based on this arrangement, effluent can be prevented from leaking to the outside of fuel cartridge 1385.

Incidentally, not shown in FIG. 16, seal member 1375 for sealing effluent recovery port 1364 may be arranged. Also, fuel outlet part 1366 may have a projection portion, similar to fuel injection part 1365 shown in FIG. 12.

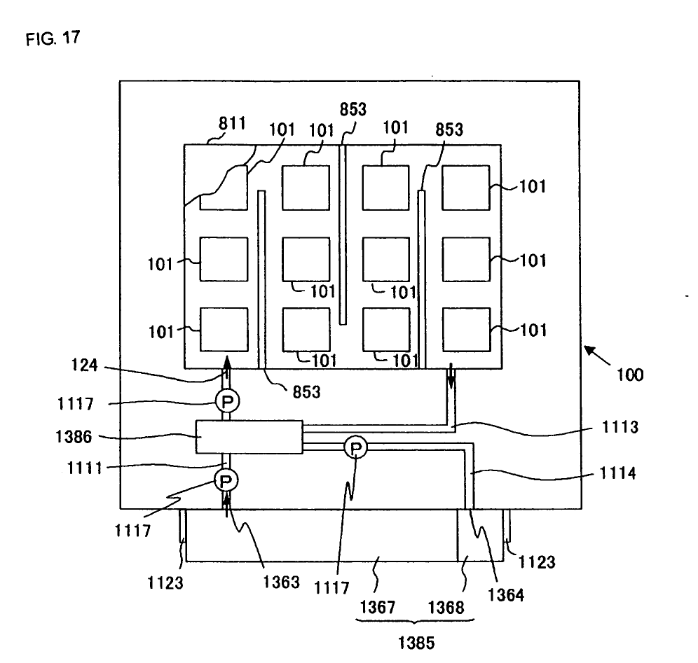

FIG. 17 is a view showing a state in which fuel cartridge 1385 in FIG. 15 is attached to fuel cell main body 100. In the third embodiment, the principle arrangement of fuel cell main body 100 is similar to that in FIG. 1, however, they are different in that effluent recovery pipe 1114, for recovering the liquid that passes through fuel electrode 102, is present in fuel cell main body 100 shown in FIG. 17, but it is not present in fuel cell main body 100 shown in FIG. 1. One end of effluent recovery pipe 1114 is connected to reservoir tank 1386. Also, another end of effluent recovery pipe 1114 is connected to effluent recovery port 1364 when fuel cartridge 1385 is attached.

Also, not shown in FIG. 17, fuel cell main body 100 has an oxidizer electrode side effluent recovery pipe for recovering the water generated by the cell reaction at the oxidizer electrode of single cell structure 101. The oxidizer electrode side effluent recovery pipe (not shown) may be also provided with pump 1117.

Here, when the fuel component is methanol, as is apparent from above-mentioned equations (1) and (2), the number of moles of the water generated at oxidizer electrode 108 is larger than the number of moles of the methanol used at fuel electrode 102. Therefore, when all effluent is continuously recovered in reservoir tank 1386, the amount of liquid in reservoir tank 1386 increases continuously. In the fuel cell in FIG. 17, since the liquid in reservoir tank 1386 can be recovered into power generation effluent chamber 1368 of fuel cartridge 1368, the fuel cell can be stably operated for a long period.

Also, since effluent discharge part 1366 is formed in the wall portion that partitions power generation effluent chamber 1368 from the outside, effluent discharge part 1366 can be removed and effluent can be discharged after fuel cartridge 1385 has been used. Therefore, fuel cartridge 1385 that is suitable for repeated use with simple arrangement can be stably obtained.

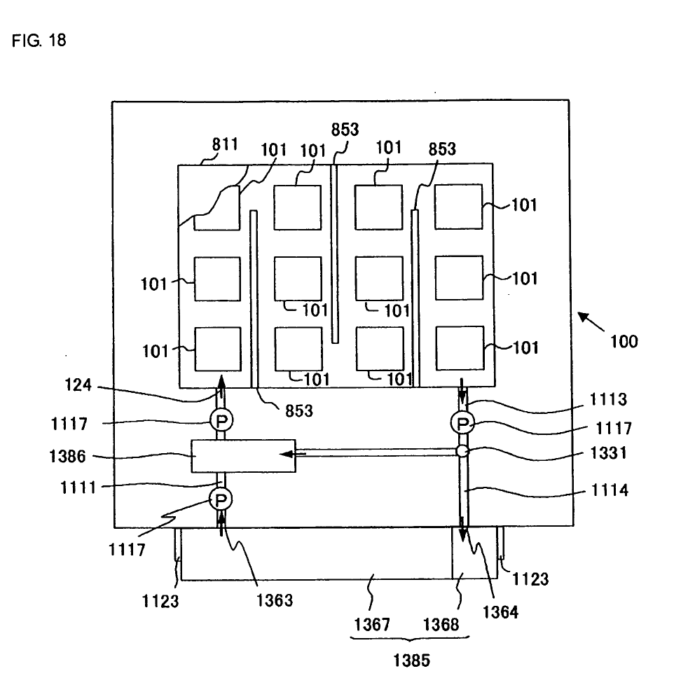

FIG. 18 is a view showing another arrangement of a fuel cell to which fuel cartridge 1385 in FIG. 15 is attached. In FIG. 18, the principle arrangement of fuel cell main body 100 is similar to the arrangement in FIG. 17, however, they are different in that effluent recovery pipe 1114 is branched for recovering the liquid that passes through fuel electrode 102 and the effluent generated at oxidizer electrode 108 from fuel recovery pipe 1113 to fuel cartridge 1385.

Flow amount adjustment valve 1331 is arranged at a bifurcation between fuel recovery pipe 1113 and effluent recovery pipe 1114. Pump 1117 is arranged in fuel recovery pipe 1113. Effluent recovery pipe 1114 is connected to effluent recovery port 1364 of fuel cartridge 1385 on the downstream side. Not shown in FIG. 18, effluent recovery pipe 1114 is also connected to the oxidizer electrode side effluent recovery pipe (not shown), and the effluent generated at the oxidizer electrode 108 is also introduced to effluent recovery pipe 1114. Also, in the oxidizer electrode side effluent recovery pipe (not shown), pump 1117 may be arranged.

In the fuel cell in FIG. 18, a part of the liquid recovered from fuel recovery pipe 1113 can be recovered from effluent recovery pipe 1114 to power generation effluent chamber 1368 of fuel cartridge 1385. Therefore, the fuel component concentration of liquid in reservoir tank 1386 can be prevented from being lowered. Also, since the effluent recovered in power generation effluent chamber 1368 can be discharged by removing fuel outlet part 1366, as described above, power generation effluent chamber 1368 can be recycled easily.

The fuel cell shown in FIGS. 17 and 18 may have a concentration sensor for detecting the concentration of the fuel component in reservoir tank 1386. Further, the fuel cell may have a control section for controlling the amount of effluent to be discharged from effluent recovery pipe 1114 to power generation effluent chamber 1368 in accordance with the concentration detected by the concentration sensor. Also, in the fuel cell in FIG. 18, liquid amount sensors may be arranged for fuel recovery pipe 1113 and oxidizer electrode side effluent recovery pipe (not shown). At this time, the liquid amount sensors can be arranged on the upstream of flow amount adjustment valve 1331, i.e., near single cell structure 101. Then, the fuel cell may have a control section for detecting the amount of recovered fuel and water generated at the oxidizer electrode by the flow amount sensor and for controlling the amount of effluent to be discharged to effluent recovery pipe 1114 based on the detected amount.

Incidentally, fuel outlet port 1363 is arranged in fuel injection part 1365 in FIG. 15. However, both may be arranged at different points, similarly to the first embodiment. Also, effluent discharge part 1366 and effluent recovery port 1364 may be arranged at different positions.

### FOURTH EMBODIMENT

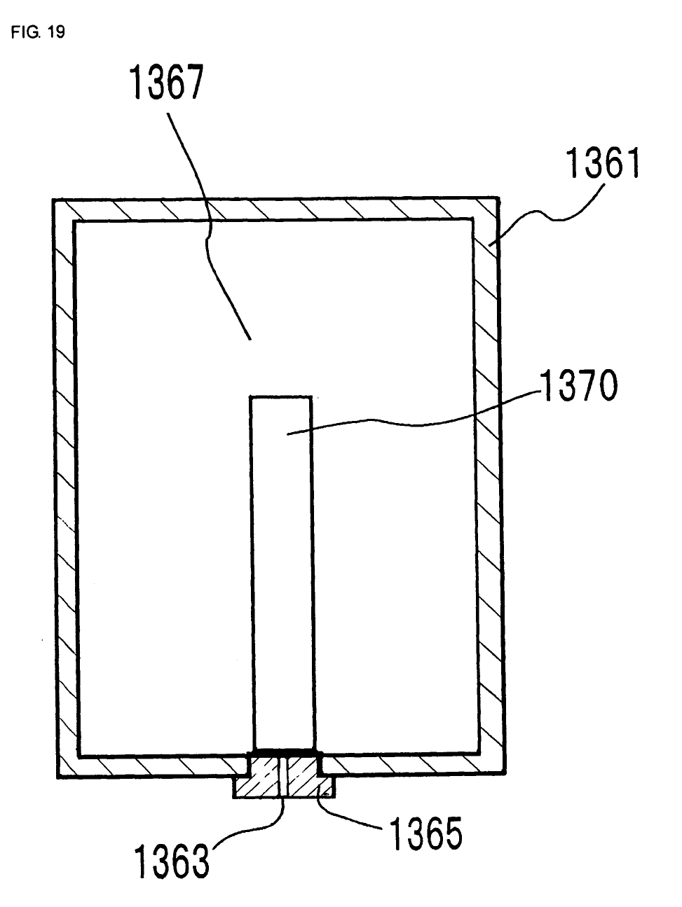

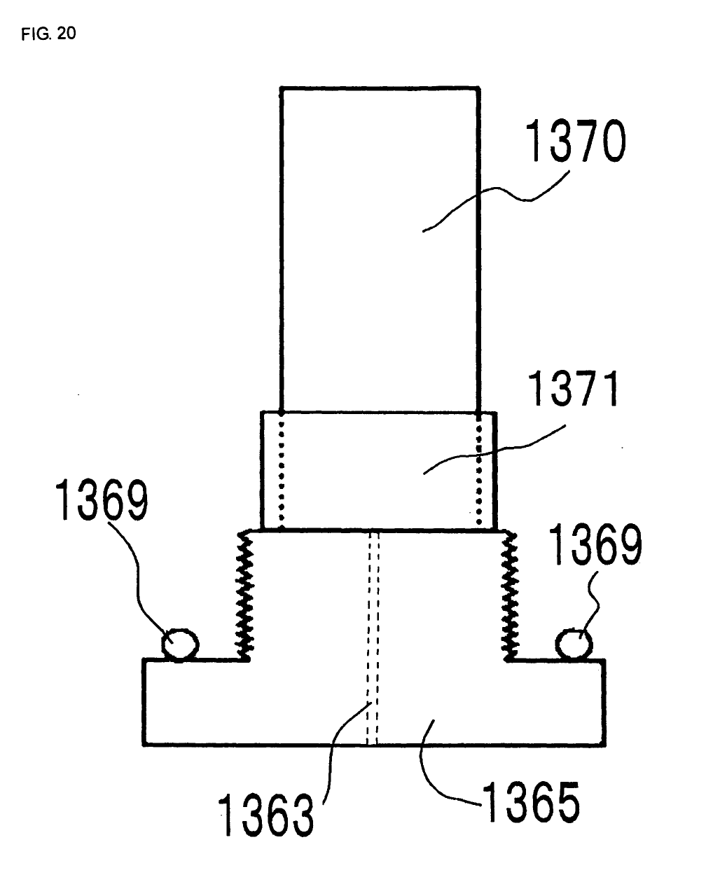

In the fuel cartridge according to the present invention, fuel injection part 1365 or effluent discharge part 1366 may be provided with a fuel absorption member for absorbing liquid fuel 124. For example, in the fuel cartridge according to the fourth embodiment of the present invention shown in FIG. 19, wicking member 1370, which is a fuel absorption member for absorbing the liquid fuel, is arranged for fuel injection part 1365. The other arrangements are similar to those of fuel cartridge 1361 according to the first embodiment shown in FIG. 2.

When fuel injection part 1365 is attached to wall portion 1372, wicking member 1370 is positioned in power generation fuel chamber 1367, and the liquid fuel in power generation fuel chamber 1367 is absorbed by wicking member 1370. The liquid fuel in power generation fuel chamber 1367 is absorbed by wicking member 1370 and then passes through fuel outlet port 1363, and is thereby supplied from fuel flow pipe 1111 (see FIG. 1) to single cell structure 101 of fuel cell main body 100.

FIG. 20 is a view showing an arrangement of fuel injection part 1365 used in the fuel cartridge in FIG. 19. In FIG. 20, wicking member 1370 is connected to fuel injection part 1365 and is removable together with fuel injection part 1365. Wicking member 1370 is inserted into bracket 1371 provided in fuel injection part 1365. When the cartridge is recycled, the condition of wicking member 1370 can be checked. Therefore, wicking member 1370 can be removed from bracket 1371 and can be replaced with a new one, as required.

Wicking member 1370 can be made of a material that absorbs the liquid fuel and is resistant to the liquid fuel, and can be made of a porous material, such as a foam material. As materials of wicking member 1370, specifically, for example, polyamide, such as polyurethane, melamine, and nylon, polyester, such as polyethylene, polypropylene, and polyethylene terephthalate, cellulose, or resin, such as polyacrylonitrile, may be used.

The fuel cartridge according to the fourth embodiment has wicking member 1370. Therefore, liquid fuel 124, which is absorbed by wicking member 1370, can be reliably supplied to fuel cell main body 100, when the amount of fuel in the fuel cartridge is reduced. Accordingly, the fuel cell can be further stably operated. Also, even if the level of the liquid surface of liquid fuel 124 in the fuel cartridge is varied, the fuel cell can be stably operated. Also, wicking member 1370 absorbs liquid fuel 124 and the remaining fuel in the cartridge can be removed easily when the cartridge is reused.

In the above, the present invention is explained with reference to the embodiments. These embodiments are examples, and a person skilled in the art will understand that various modifications in combinations of each element and each process of the abovementioned embodiments are available and that these modifications are within the scope of the present invention.

For example, in each above-mentioned embodiment, fuel injection part 1365 is a seal member which seals the opening (fuel inlet port) arranged in wall portion 1372. However, there is no limitation on the arrangement of fuel inlet part 1365. For example, a construction can be used in which a flat plate that covers the fuel inlet port arranged in wall portion 1372 can be moved to open and close the fuel inlet port. Also, fuel inlet part 1365 may be a cap for covering the fuel inlet port arranged in wall portion 1372.

Also, in each above-explained embodiment, Y-shaped groove 1377 is formed in fuel injection part 1365. However, shapes of grooves are not limited to Y-shaped groove 1377, and another shape is available.

Also, packing made of Teflon (registered trademark) or the like can be used for sealing fuel injection part 1365 and wall portion 1372, instead of O-ring 1369.

Further, there is no limitation on the above-mentioned arrangement of fuel cell main body 100, and various aspects are available. For example, an arrangement may be simplified, like the arrangement with no reservoir tank 1386.

1. A fuel cartridge for a fuel cell, that is stored with liquid fuel to be directly supplied to a fuel electrode of the fuel cell and that is attachable and detachable to/from said fuel cell, is characterized in that the fuel cartridge comprises:
a fuel supply part for supplying said liquid fuel to said fuel cell; and
a fuel introduction part that can be opened and closed and that is used for refilling said liquid fuel into said fuel cartridge for said fuel cell.

2. The fuel cartridge for the fuel cell according to claim 1, is characterized in that
an opening is arranged in a wall portion of a storage chamber stored with said liquid fuel,
said fuel introduction part includes said opening and a closing member for closing said opening, and
said closing member is attachable and detachable to/from said wall portion.

3. The fuel cartridge for the fuel cell according to claim 1 or 2, is characterized in that said fuel supply part is arranged in said fuel introduction part.

4. The fuel cartridge for the fuel cell according to claim 1 or 2, is characterized in that said fuel supply part is sealed by a self-sealing member.

5. The fuel cartridge for the fuel cell according to claim 1 or 2, is characterized in that
the fuel cartridge comprises a first chamber for holding said liquid fuel; a second chamber to which effluent that has passed through said fuel electrode is introduced, and a partition wall for partitioning said first chamber and said second chamber,
said first chamber has said fuel supply part and said fuel introduction part, and
said second chamber has an effluent recovery port to which said effluent recovered from said fuel electrode is introduced.

6. The fuel cartridge for the fuel cell according to claim 5, is characterized in that said second chamber has an effluent discharge part that can be opened and closed and that is used to discharge said effluent.

7. The fuel cartridge for the fuel cell according to claim 6, is characterized in that said effluent discharge part is provided with said effluent recovery port.

8. The fuel cartridge for the fuel cell according to claim 1 or 2, is characterized in that said effluent recovery port is sealed by a self-sealing member.

9. The fuel cartridge for the fuel cell according to claim 1 or 2, is characterized in that a part of said fuel introduction part is made by a fuel absorption member that absorbs said liquid fuel, and wherein said fuel absorption member is arranged in said fuel cartridge.

10. The fuel cartridge for the fuel cell according to claim 9, is characterized in that said fuel absorption member is attachable and detachable to/from said fuel introduction part

11. The fuel cartridge for the fuel cell according to claim 1 or 2, is characterized in that said fuel cartridge can be stored in an electronic device.

12. A fuel cell is characterized in that the fuel cell comprises a fuel cell main body having a fuel electrode; and the fuel cartridge for the fuel cell according to claim 1 or 2, which is stored with liquid fuel to be directly supplied to said fuel electrode.
